(19) United States
(12) Patent Application Publication
(10) Pub. No.: US 2007/0098191 A1
(43) Pub. Date: May 3, 2007

(54) Audio system of a tablet personal computer and the speaker orientating method thereof

(76) Inventors: Tai-Shing Wan, Tao Yuan Shien (TW); Ming-Yang Liu, Hsinchu Shien (TW); Hsin-Feng Tsai, Pao Chiao City (TW)

Correspondence Address: RABIN & BERDO, P.C., Suite 500, 1101 14 Street, N.W., Washington, DC, 20005, US

(21) Appl. No.: 11/374,212

(22) Filed: Mar. 14, 2006

(30) Foreign Application Priority Data
Oct. 28, 2005 (TW) 94137900

(51) Int. Cl. H04R 5/02; H04R 1/02

(52) U.S. Cl. 381/306; 381/333; 381/388

(57) ABSTRACT

An audio system of a tablet personal computer and the speaker orientating method thereof are provided, wherein the audio system comprises at least two speakers mounted on a frame of the tablet personal computer, an angle detector mounted on the frame, an audio driver used to drive the speakers, and an audio-adjusting device. The audio driver can adjust the sound field of each speaker in accordance with a set of audio parameters. The angle detector is used to generate positional data as the frame is rotated relative to the ground. The audio adjusting device is used to renew the audio setting in accordance with the positional data to make the speakers provide an audio stereophony substantially equal to the predetermined stereophony.

### RELATED APPLICATIONS

The present application is based on, and claims priority from, Taiwan Application Serial Number 94137900, filed Oct. 28, 2005, the disclosure of which is hereby incorporated by reference herein in its entirety.

### FIELD OF THE INVENTION

The present invention relates to a tablet personal computer, and particularly relates to an audio system of a tablet personal computer and the orientating method thereof.

### BACKGROUND OF THE INVENTION

Manufacturers have provided tablet personal computers offering several advantages, such as powerful calculation ability, broad screens, and particularly intuitive graphic input devices similar to those found in personal digital assistants, all of which can improve users' operation habits, provide more convenience and make personal computers more available for various circumstances.

Generally, an audio system of a conventional portable computer (such as a laptop computer) has several speakers set on predetermined locations to provide stereophony. For example these speakers are fixed adjacent to the screen of the laptop personal computer to provide sound fields directed both from right and left sides of the screen. Since a user should face the screen of the laptop computer while operating, the stereophony generated by the speakers is rather stable. Typically, a tablet personal computer can be operated at every orientation; however each speaker of the tablet personal computer is fixed on predetermined locations. When the relative position of the user to the fixed speakers is changed, the tablet personal computer forms different and perhaps undesirable stereophony.

FIGS. 1A to 1C illustrate the arrangement of plural speakers fixed on a conventional tablet personal computer. FIG. 1A illustrates the initial relative position of the speakers 101 and 102 fixed on the bottom positions of the tablet personal computer adjacent to the screen 100 thereof. The sound fields respectively provided by the two speakers either from the right side or the left side of the screen 100 are mixed to form a predetermined stereophony, wherein the speaker 101 provides the left sound field and the speaker 102 provides the right sound field.

FIG. 1B illustrates the relative position of the speakers 101 and 102 when the tablet personal computer of FIG. 1A is rotated 90° clockwise. As the tablet personal computer is rotated, the speakers 101 and 102 are moved to the left side of the screen 100 relatively. The speakers 101 and 102 both provide sound fields from the left side of the screen 100 and provide no sound field from the right side of the screen 100; thus the stereophony generated by the speakers 101 and 102 is different from the predetermined stereophony.

FIG. 1C illustrates the relative position of the speakers 101 and 102 when the tablet personal computer of FIG. 1A is rotated 180° clockwise. As the tablet personal computer is rotated, the relative position of the speakers 101 and 102 is reversed relative to that of FIG. 1A. Effectively, the speaker 101 is removed to the right side of the screen 100 to provide a right sound field, and the speaker 102 is removed to the left side of the screen 100 to provide a left sound field.

Thus, the predetermined stereophony cannot be duplicated for every setting, the performance of audio systems of tablet personal computers are adversely affected, and tablet personal computers are thereby limited in their operating orientations and convenience.

### SUMMARY OF THE INVENTION

One aspect of present invention is to provide an audio system for a tablet personal computer and the orientating method thereof to overcome the aforementioned problems and to improve the audio performance of the tablet personal computer.

In accordance with the objective of the present invention, an audio system is provided to provide the tablet personal computer a predetermined stereophony.

In a preferred embodiment of the present invention, the audio system comprises at least two speakers, an audio driver, an angle detector and an audio-adjusting device, wherein each speaker mounted on a frame of the tablet personal computer has a distance apart from another.

The audio driver is used for driving the speakers, wherein the audio driver may drive the speakers in accordance with a set of audio parameters to adjust the outputting sound field of each speaker. For example each speaker may be assigned to provide a left sound field, to provide a right sound field, or to mute by the set of audio parameters.

The angle detector mounted on the frame of the tablet personal computer is used for generating positional data as the frame is rotated relative to the ground.

The audio-adjusting device is used to renew the set of audio parameters in accordance with the positional data.

According to the aforementioned embodiment, the orientating method of the audio system comprises the following steps: First, at least two speakers are mounted on the frame of a tablet personal computer, wherein each of the speakers has a distance apart from another. An audio diver is provided to adjust the output of these speakers in accordance with a set of audio parameters, wherein each speaker may be assigned to provide a left sound field, to provide a right sound field, or to mute by the set of audio parameters. An angle detector is mounted on the fame of the tablet personal computer used for generating positional data as the frame is rotated relative to the ground. The audio parameters may be renewed in accordance with the positional data so as to control each of the speakers to form a stereophony substantially equal to a predetermined stereophony.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A illustrates the initial relative position of different speakers fixed on the bottom positions of a conventional tablet personal computer adjacent to the screen thereof.

FIG. 1B illustrates the relative position of different speakers when the tablet personal computer of FIG. 1A is rotated 90° clockwise.

FIG. 1C illustrates the relative position of different speakers when the tablet personal computer of FIG. 1A is rotated 180° clockwise.

FIG. 2A illustrates the initial relative position of the different speakers to the ground, in accordance with the first embodiment of the present invention.

FIG. 2B illustrates the relative position of different speakers when the tablet personal computer of FIG. 2A is rotated 90° clockwise.

FIG. 2C illustrates the relative position of different speakers when the tablet personal computer of FIG. 2A is rotated 180° clockwise.

FIG. 2D illustrates the relative position of different speakers when the tablet personal computer of FIG. 2A is rotated 270° clockwise.

FIG. 3A illustrates the initial relative position of the different speakers to the ground, in accordance with the second embodiment of the present invention.

FIG. 3B illustrates the relative position of different speakers when the tablet personal computer of FIG. 3A is rotated 90° anti-clockwise.

FIG. 3C illustrates the relative position of different speakers when the tablet personal computer of FIG. 3A is rotated 180° anti-clockwise.

FIG. 3D illustrates the relative position of different speakers when the tablet personal computer of FIG. 3A is rotated 270° anti-clockwise.

FIG. 4A is a block diagram illustrating the orientating method of an audio system 400 of a tablet personal computer to duplicate a predetermined stereophony at different rotating angles of the tablet personal computer relative to the ground.

FIG. 4B illustrates the initial relative position of different speakers fixed on a tablet personal computer adjacent to the screen thereof, in accordance with a preferred embodiment of the present invention.

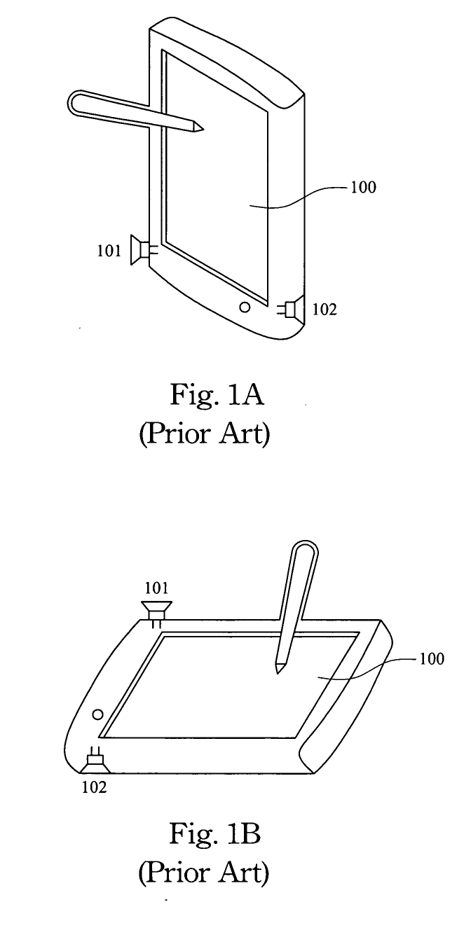

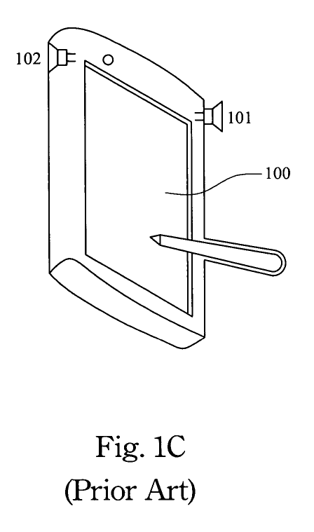

### DETAILED DESCRIPTION OF THE PREFERRED EMBODIMENT

The features of the present invention are to provide at least two speakers, an audio driver, an angle detector and audio-adjusting device for a tablet personal computer to duplicate a predetermined stereophony. When the tablet personal computer is rotated relative to the ground, the angle detector can detect the relative position of the tablet personal computer to the ground for generating a positional data; the audio-adjusting device can renew a built-in audio parameter/positional data shit in accordance with the positional data, providing the audio driver to control these speakers to output a stereophony substantially equal to a predetermined stereophony.

The foregoing aspects and many of the attendant advantages of this invention will become more readily appreciated as the same become better understood by reference to the following embodiments of an audio system of a tablet personal computer.

Embodiment 1

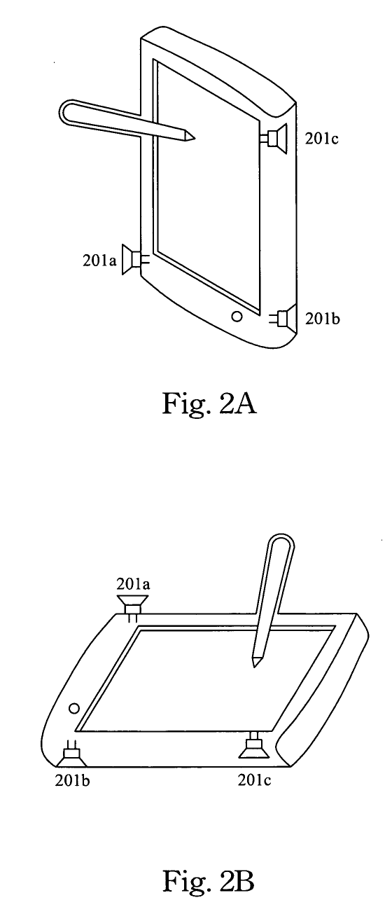

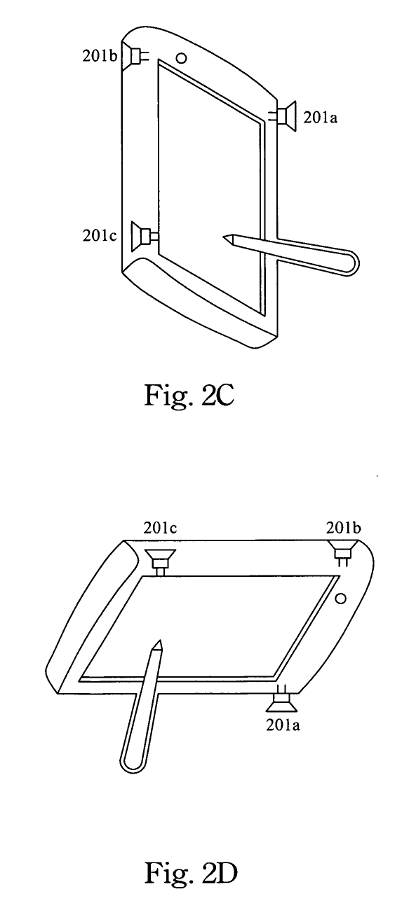

FIGS. 2A to 2D illustrate the arrangement of plural speakers fixed on a tablet personal computer at different angles relative to the ground, in accordance with the first preferred embodiment of the present invention.

In the first embodiment of the present invention, the tablet personal computer 200 comprises three speakers, such as 201 a, 201b and 201c.

FIG. 2A illustrates the initial relative position of the speakers 201a, 201b and 201c to the ground, wherein these speakers are respectively fixed on the tablet personal computer 200 adjacent to the screen thereof. The speakers 201a and 201b are turned on and the speaker 201c is turned off, wherein the speaker 201a provides a left sound field and the speaker 201b provides a right sound field. When the tablet personal computer 200 is rotated clockwise, the positional data, such as rotating angles 0°, 90°, 180° or 270° can be measured by an angle detector to provide the audio system for adjusting these speakers to output sound fields. In the present embodiment, the audio system of the tablet personal computer 200 comprises an application-programming interface (API) system provided by the Microsoft Corporation, wherein the API system includes a built-in audio parameter/positional data shit, shown as Table 1:

TABLE 1

| Positional Data | Speakers Condition | | |
|---|---|---|---|
| (Rotating Angle) | Speaker 201a | Speaker 201b | Speaker 201c |
| 0° | L (Left | R (Right | OFF |
| | Sound field) | Sound field) | |
| 90° | OFF | L | R |
| 180° | R | L | OFF |
| 270° | OFF | R | L |

The audio parameters can be varied by the API system depending on the positional data corresponding to the parameter/positional data shit to control the speakers 201a, 201b and 201c condition.

When the tablet personal computer 200 is rotated about 90° clockwise (shown as FIG. 2B), the speakers' condition is varied by the API system in accordance with the parameter/positional data shit, wherein the speaker 201a could be turned off, the speaker 201b could be turned on to provide a left sound field, and the speaker 201c could be turned on to provide a right sound field.

Similarly, when the tablet personal computer 200 is rotated about 180° clockwise (shown as FIG. 2C), the speakers' condition is varied by the API system, wherein the speaker 201c could be turned off, the speakers 201b could be turned on to provide a left sound field, and the speaker 201a could be turned on to provide a right sound field. When the tablet personal computer 200 is rotated about 270° clockwise (shown as FIG. 2D), the speaker 201a could be turned off, the speaker 201c could be turned on to provide a left sound field, and the speaker 201b could be turned on to provide a right sound field.

Embodiment 2

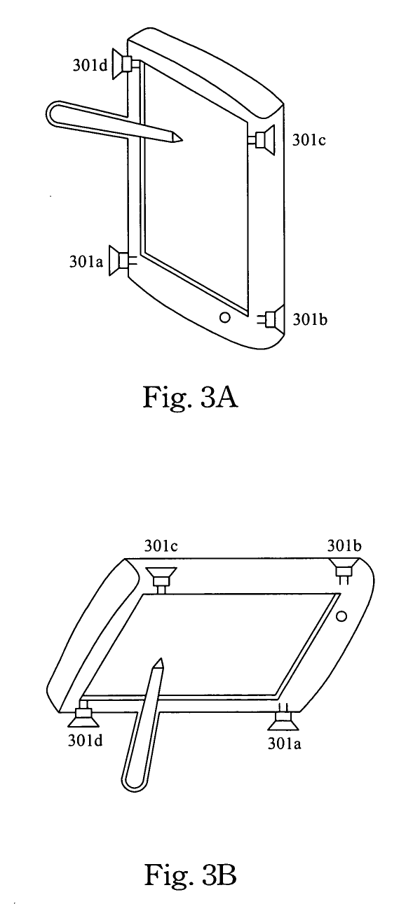

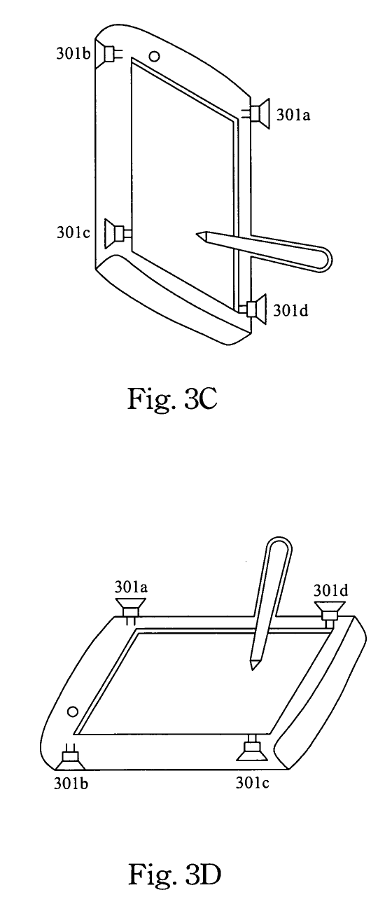

FIGS. 3A to 3D illustrate the arrangements of plural speakers fixed on a tablet personal computer at different rotating angles relative to the ground, in accordance with the second preferred embodiment of the present invention.

In the first present invention, the tablet personal computer 300 comprises four speakers, such as 301a, 301b, 301c, and 301d. Compared to the first embodiment, the four speakers are always turned on, and the outputting sound field of each speaker may be varied depending on different rotating angles of the tablet personal computer relative to the ground.

FIG. 3A illustrates the initial relative position of the speakers 301a, 301b, 301c, and 301d to the ground, wherein these speakers are respectively fixed on the four corners of the tablet personal computer 300. The speakers 301a and 301d provide a left sound field and the speakers 301b and 301c provide a right sound field. When the tablet personal computer 300 is rotated anti-clockwise, the positional data, such as rotating angles 0°, 90°, 180° or 270° can be measured by an angle detector to provide the audio system for adjusting these speakers to output sound fields. In the present embodiment, the audio system of the tablet personal computer 200 comprises an application-programming interface (API) system provided by the Microsoft Corporation, wherein the API system includes a built-in audio parameter/positional data shit, shown as Table 2:

TABLE 2

| | Speaker Condition | | | |
|---|---|---|---|---|
| Positional Data | Speaker | Speaker | | |
| (Rotating Angle) | 301a | 301b | Speaker 301c | Speaker 301d |
| 0° | L | R | R | L |
| 90° | R | R | L | L |
| 180° | R | L | L | R |
| 270° | L | L | R | R |

The audio parameters can be varied by the API system depending on the condition of the speakers 301a, 301b, 301c and 301d.

When the tablet personal computer 300 is rotated about 90° anti-clockwise (shown as FIG. 3B), the speakers' condition is varied by the API system in accordance with the parameter/positional data shit, wherein the speakers 301a and 301b could provide a right sound field, and speakers 301c and 301d could provide a left sound field.

Similarly, when the tablet personal computer 300 is rotated about 180° anti-clockwise (shown as FIG. 3C), the speakers' condition is also varied by the API system, wherein the speakers 301a and 301d could provide a right sound field, and speakers 301b and 301c could provide a left sound field. When the tablet personal computer 300 is rotated about 270° anti-clockwise (shown as FIG. 3D), the speakers 301c and 301d could provide a right sound field, and speakers 301a and 301b could provide a left sound field.

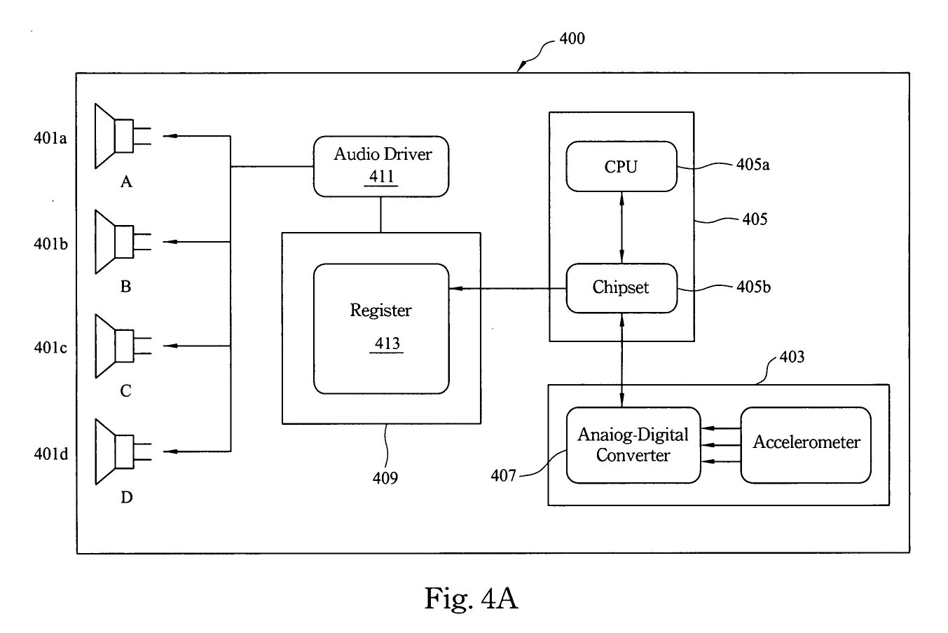

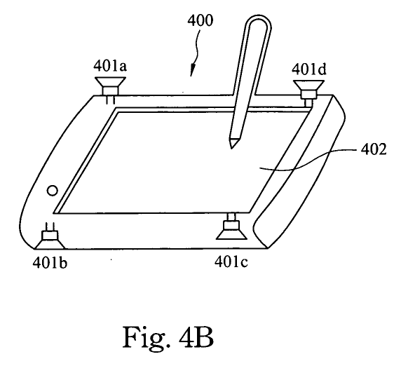

FIG. 4A is a block diagram illustrating the orientating method of an audio system 400 of a tablet personal computer to duplicate a predetermined stereophony at different rotating angles of the tablet personal computer relative to the ground. First, an audio system 400 comprising at least two speakers, an audio driver, an angle detector and audio-adjusting device is provided. The audio system 400 of the tablet personal computer comprises four speakers, such as the speakers 401a, 401b, 401c, and 401d mounted adjacent to the screen of the tablet personal computer, wherein each speaker has a distance apart from another. In the preferred embodiment of the present invention, the tablet personal computer is rectangular, the speakers 401a, 401b, 401c, and 401d are mounted on the four corners of the tablet personal computer respectively (shown as FIG. 4B).

The audio driver 411 electrically connects to each of the speakers 401a, 401b, 401c, and 401d. The outputting sound fields of the speakers 401a, 401b, 401c, and 401d are controlled by the audio driver 411 in accordance with a set of audio parameters, wherein the audio parameters are used to determine the outputting volume, frequency, and the on/off condition of each speaker, so as to determine each speaker to provide a left sound field or to provide a right sound field for duplicating a predetermined stereophony. The audio driver may be a chipset, software, a single chip, or the arbitrary combination thereof for audio control.

The angle detector 403 electrically connected to the central processing system 405 of the tablet personal computer is used to generate the positional data as the tablet personal computer is rotated relative to the ground. In the preferred embodiment of the present invention, the angle detector 403 is a micro-electrical mechanical device comprising an accelerometer used to measure the rotating angles and the rotating direction of the tablet personal computer's frame 402 and to provide the central processing system 405 of the tablet personal computer digital signals or analog signals for calculating the relative position of the speakers 401a, 401b, 401c, 401d and the frame 402 relative to the ground for providing the positional data. The positional data, such as the relative position about the frame 402 and the speakers 401a, 401b, 401c, and 401d to the ground, can be calculated to determine the rotational displacement of each speaker.

In the other preferred embodiment of the present invention, the angle detector 403 further comprises an analog-to-digital converter (ADC) used to transform the analog signals into digital signals measured by the angle detector 403 before the rotational displacement calculation conducted by the central processing system 405. It must be noted that the central processing system 405 comprises the central processing unit (CPU) 405a of the tablet personal computer and other programmable system, such as a chipset 405b.

The audio-adjusting device 409 set in the tablet personal computer and electrically connected to the angle detector 403 and the audio driver 411 is used to renew the set of audio parameters in accordance with the rotational displacement of the speakers to control the audio driver to adjust the sound fields of the speakers to form a stereophony substantially equal to a determined stereophony.

The audio-adjusting device 409 may be a single chip, a chipset, software or the arbitrary combination thereof. In some embodiments of the present invention, the audio-adjusting device 409 comprises a built-in parameter/positional data shit used to define the relationships between the audio parameter and the positional data, wherein the positional data is generated by the angle detector 403 as the tablet personal computer is rotated relative to the ground. In some other embodiments of the present invention, the audio-adjusting device 409 further comprises an indicator, such as a screen or indicating lamps used to display the positional data.

In some preferred embodiments of the present invention, the audio-adjusting device comprises a register 413 used to store the positional data, such as the rotational displacement of the speakers generated and calculated by the angle detector 403 and the central processing system 405 as the tablet personal computer is rotated relative to the ground. When the positional data is varied, the audio-adjusting device 409 can renew the audio parameters for the audio diver 411 in accordance the built-in audio parameter/positional shift. Meanwhile, the audio diver 411 can monitor the variation of the audio parameters to adjust the outputting sound field of each speaker for forming a stereophony substantially equal to a predetermined stereophony.

Of yet another preferred embodiment of the present invention, the audio-adjusting device comprises an application program, such as the application-programming interface (API) system provided by the Microsoft Corporation, by which the user can define predetermined functions to control the audio driver 411. For example, the audio parameter/positional data shit can be built in the API system used to renew the audio parameters for the audio driver 411 to adjust the outputting sound field of each speaker; thus the outputting volume, frequency and the on/off condition of each speaker are determined to assign each speaker to provide a left sound field, to provide a right sound field or to mute.

It must be noted that when the positional data is varied, the audio-adjusting device 409 can automatically renew the audio parameters by the API system or display the positional data on the screen to inform the user optionally calling the API system to renew the audio parameters. Thus, the user has more freedom to adjust the audio system 400.

In addition, the audio-adjusting device may comprise a manual controller, by which the user can renew the audio parameter in accordance with the variation of positional data displayed on the screen to adjust the outputting sound file of each speaker for duplicating the predetermined stereophony.

According to the aforementioned embodiments, the features of the present invention are providing at least two speakers to form a predetermined stereophony for a tablet personal computer. When the tablet personal computer is rotated relative to the ground, a angle detector is used for measuring and generating positional data of the rotated tablet personal computer while an audio-adjusting device is used to force the audio driver to adjust the outputting sound field of each speaker in accordance with an audio parameter/positional data shit built in the audio-adjusting device to form a stereophony substantially equal to the predetermined stereophony.

As is understood by a person skilled in the art, the foregoing preferred embodiments of the present invention are illustrative of the present invention rather than limiting of the present invention. It is intended that various modifications and similar arrangements included within the spirit and scope of the appended claims are covered, the scope of which should be accorded the broadest interpretation so as to encompass all such modifications and similar structure.

What is claimed is:

1. An audio system, set in a tablet personal computer to provide a predetermined stereophony comprising:
at least two speakers, set on a frame of the tablet personal computer, wherein each of the speakers has a distance apart from another;
an audio driver, used to drive the speakers and adjust the sound field outputted by each of the speakers in accordance with a set of audio parameters that can assign each of the speakers to provide a left sound field, to provide a right sound field or to mute;
an angle detector, set on the frame of the tablet personal computer used for generating a positional data as the frame is rotated relative to the ground; and
an audio-adjusting device, used to renew the set of audio parameters to make the speakers output a stereophony substantially equal to the predetermined stereophony.

2. The audio system in accordance with claim 1, wherein the angle detector comprises an accelerometer used to measure the rotating angles and the rotating direction of the frame to calculate the relative position of the speakers and the frame to the ground for providing the positional data.

3. The audio system in accordance with claim 1, wherein the set of audio parameters can further control the outputting volume and frequency of each speaker.

4. The audio system in accordance with claim 1, wherein the audio driver comprises a single chip, chipset, software, and the arbitrary combination thereof.

5. The audio system in accordance with claim 1, wherein the audio adjusting device comprises an indicator used to display the positional data.

6. The audio system in accordance with claim 5, wherein the audio adjusting device comprises a manual controller by which a user can renew the set of audio parameters in accordance with the positional data displayed on the indicator.

7. The audio system in accordance with claim 1, wherein the audio adjusting device comprises a register used to store the positional data, wherein when the positional data is varied, the audio-adjusting device can renew the set of audio parameters automatically.

8. The audio system in accordance with claim 1, wherein the audio adjusting device comprises an application program by which to call an application-programming interface (API) system to renew the audio parameters

9. The audio system in accordance with claim 1, wherein when the audio system comprises more than three speakers, these speakers are coplanar.

10. An orientating method of an audio system set in a tablet personal computer to provide a predetermined stereophony, comprising the steps of:
setting at least two speakers on a frame of the tablet personal computer, wherein each of the speakers has a distance apart from another;
providing an audio driver, used to drive the speakers and adjust the sound field outputted by each of the speakers in accordance with a set of audio parameters that can assign each of the speakers to provide a left sound field, to provide a right sound field, or to mute;
setting an angle detector on the frame of the tablet personal computer for generating a positional data as the frame is rotated relative to the ground; and
renewing the set of audio parameters to make the speakers output a stereophony substantially equal to the predetermined stereophony.

11. The orientating method in accordance with claim 10, wherein the step of renewing the set of audio parameters comprises controlling the outputting volume and frequency of each speaker.

12. The orientating method in accordance with claim 10, wherein an application program is used to call an API system for renewing the set of audio parameters.

13. The orientating method in accordance with claim 10, wherein an API system is used for renewing the set of audio parameters automatically.

14. The orientating method in accordance with claim 10, wherein a manual controller is used for renewing the set of audio parameters.
